(19) United States
(12) Patent Application Publication
(10) Pub. No.: US 2023/0119576 A1
(43) Pub. Date: Apr. 20, 2023

(54) AN EIGHT-WAY INTERCHANGE

(71) Applicant: Fuquan Zhang, Inner Mongolia Autonomous Region (CN)

(72) Inventors: Dong Zhang, Inner Mongolia Autonomous Region (CN); Fuquan Zhang, Inner Mongolia Autonomous Region (CN)

(21) Appl. No.: 17/956,683

(22) Filed: Sep. 29, 2022

(30) Foreign Application Priority Data
Oct. 18, 2021 (CN) 202111209258.9

(51) Int. Cl. E01C 1/04; E01C 1/00

(52) U.S. Cl. CPC E01C 1/04; E01C 1/002

(57) ABSTRACT

The invention belongs to the technical field of interchange, in particular to an eight-way interchange. The following technical scheme is proposed, comprising a first forked road, a third forked road, a second forked road, a fourth forked road, a fifth forked road, a sixth forked road, a seventh forked road and an eighth forked road. The first forked road and the third forked road, the second forked road and the fourth forked road constitute a cross overpass, the first forked road and the third forked road constitute an upper two-way straight lane, the second forked road and the fourth forked road constitute a lower two-way straight lane. The invention has simple structures. Motor vehicles can complete straight driving, left turn, right turn and U-turn through upper straight two-way lanes, lower straight two-way lanes and eight right-turn lanes, realizing the interconnection of all eight forked roads in 16 traffic directions.

### 1. TECHNICAL FIELD

The invention relates to the technical field of interchange, in particular to an eight-way interchange.

### 2. BACKGROUND ART

The full expression of an interchange is “three-dimensional crossing bridge”, which refers to a modern bridge built at the intersection of two or more crossing roads with upper and lower layer and multi-directional non-interference. Due to the high construction cost, it is usually only constructed at the intersection between expressways, urban arterial roads or freeways. The main function is to facilitate the vehicles in all directions run smoothly without being controlled by the traffic lights at the intersection.

The existing road intersections are usually built with overpasses to solve the multi-fork traffic. The roads are provided with various interchanges at the upper and lower or multi-layer intersections, such as turbine-type interchanges, etc. These interchanges generally cover a large area, have many layers, require a large amount of engineering work and high construction costs. Problems such as the communication of multi-fork interchanges are not well resolved, and the adaptive vehicle speed is low. Therefore, the invention proposes an eight-way interchange against the above problems.

### 3. SUMMARY OF THE INVENTION

The purpose of the invention is to solve the defects of the existing technology that the interchanges generally cover a large area, have many layers, require a large amount of engineering work and high construction costs, and tend to cause traffic jam. Therefore, an eight-way interchange is proposed.

In order to realize the above purpose, the following technical solution is adopted:

An eight-way interchange, comprises a first forked road, a third forked road, a second forked road, a fourth forked road, a fifth forked road, a sixth forked road, a seventh forked road and an eighth forked road; the first forked road, the third forked road, the second forked road and the fourth forked road constitute a cross overpass, the first forked road and the third forked road constitute an upper two-way straight lane, the second forked road and the fourth forked road constitute a lower two-way straight lane, the upper two-way straight lane includes two first upper accessorial bridges and two first upper downward left-turn relief roads, and the two first upper accessorial bridges are respectively connected to both sides of the upper two-way straight lane; the lower two-way straight lane includes two first lower relief roads and two first lower upward left-turn relief roads, the first lower upward left-turn relief roads are respectively connected with the inner sides of the two first lower relief roads and the two first upper accessorial bridges, the two first upper downward left-turn relief roads are respectively connected with the two first upper accessorial bridges and the two first lower relief roads;

the fifth forked road is connected with the outside of the first lower relief road through the one-way inward straight lane of the forked road, and is connected to the outside of the first upper accessorial bridge through the one-way outward straight lane of the accessorial bridge; the sixth forked road is connected to the outside of the first upper accessorial bridge through the one-way inward straight lane of the accessorial bridge, and is connected to the outside of the first lower relief road through the one-way outward straight lane of the relief road; the seventh forked road is connected to the outside of the first lower relief road through the one-way inward straight lane of the forked road, and is connected to the outside of the first upper accessorial bridge through the one-way outward straight lane of the accessorial bridge; the eighth forked road is connected to the outside of the first upper-floor accessorial bridge through the one-way inward straight lane of the accessorial bridge, and is connected to the outside of the first lower relief road through the one-way outward straight lane of the relief road;

the first forked road is connected with the outside of the sixth forked road through the right-turn lane of the first forked road, the sixth forked road is connected with the outside of the second forked road through the right-turn lane of the sixth forked road, the second forked road is connected to the outside of the seventh forked road through the right-turn lane of the second forked road, the seventh forked road is connected to the outside of the third forked road through the right-turn lane of the seventh forked road, the third forked road is connected to the outside of the eighth forked road through the right-turn lane of the third forked road, the eighth forked road is connected to the fourth forked road through the right-turn lane of the eighth forked road, the fourth forked road is connected to the outside of the fifth forked road through the right-turn lane of the fourth forked road, and the fifth forked road is connected to the first forked road though the right-turn lane of the fifth forked road;

the two first upper accessorial bridges are respectively connected to both sides of the upper two-way straight lane, and the two first upper downward left-turn relief roads are respectively connected with the inner sides of the two first upper accessorial bridges;

the first forked road, the third forked road, the second forked road, the fourth forked road, the fifth forked road, the sixth forked road, the seventh forked road and the eighth forked road all have a right-turn lane diverging from the left side of the one-way inward straight lane to connect with the adjacent forked road from the outside.

Preferably, the number of lanes of the upper two-way straight lane and the lower two-way straight lane is six, the number of lanes of the first forked road, the third forked road, the second forked road, the fourth forked road, the fifth forked road, the sixth forked road, the seventh forked road and the eighth forked road is two-way 6-lane, and the number of the right-turn lanes that diverge from the one-way inward straight lane of the eight forked roads is respectively two.

Preferably, the number of lanes on the first lower relief road and the two first lower upward left-turn relief roads is four, and the virtual roundabouts formed have corresponding traffic signs.

Preferably, the first forked road, the third forked road, the second forked road, the fourth forked road, the fifth forked road, the sixth forked road, the seventh forked road and the eighth forked road are all provided with corresponding traffic signs of crossing prohibition and isolation belts.

The eight-way interchange, comprises an upper two-way straight lane and a lower two-way straight lane;

the upper two-way straight lane includes two second upper accessorial bridges, two second upper downward left-turn relief roads, and two upper one-way auxiliary roads; the two second upper accessorial bridges are respectively connected to the both sides of the upper two-way straight lanes, and the upper one-way auxiliary roads are respectively connected to the second upper accessorial bridges;

the lower two-way straight lane comprises two second lower relief roads, two second lower upward left-turn relief lanes, and two lower one-way relief roads; the two second lower upward left-turn relief lanes are respectively connected to the inner side of the two second lower relief roads and the two second upper accessorial bridges, the lower one-way relief roads communicate with the second lower relief roads, the two second upper downward left-turn relief roads are respectively connected to the two second upper accessorial bridges and the two second lower relief roads.

Compared with the prior art, the advantages of the invention are:

1. In the invention, the first upper accessorial bridges, the first upper downward left-turn relief roads, the first lower relief roads and the first lower upward left-turn relief roads constitute a virtual roundabout. No need to set traffic lights, motor vehicles can complete left turn, right turn, U-turn and other operations in any direction through the virtual roundabout. An interchange with all forked roads interconnected in 16 traffic directions is formed, which greatly improves the efficiency of vehicle traffic.

2. In the invention, the number of lanes of the eight forked roads is all two-way 6-lane, and the number of the right-turn lanes that diverge from the one-way inward straight lane of the eight forked roads is more than two, which can improve the traffic capacity of vehicles.

3. In the invention, the first upper accessorial bridges, the first upper downward left-turn relief roads, the first lower relief roads and the first lower upward left-turn relief roads constitute a virtual roundabout. The number of lanes should be four, which should be selected according to the traffic flow to increase the traffic capacity of the vehicles.

4. In the invention, the entire interchange is provided with corresponding traffic signs of prohibition of crossing and isolation belts to improve traffic safety. Green belts are provided on both sides of the interchange, which improves the traffic environment.

5. In the invention, by setting up signs and arrows, and playing traffic animations on the display screen, it is convenient for users who enter the interchange for the first time to find the exit quickly and accurately, so that the vehicles will not be congested and cause traffic jam.

The invention has simple structures. Motor vehicles can complete straight driving, left turn, right turn and U-turn through upper straight two-way lanes, lower straight two-way lanes and eight right-turn lanes, realizing the interconnection of all eight forked roads in 16 traffic directions. In addition, traffic lights are not required, which greatly improves traffic efficiency, allows cars to run smoothly, and can reduce the possibility of traffic accidents; in addition, an eight-way interchange can be derived from a variety of interchanges.

### 4. BRIEF DESCRIPTION OF ACCOMPANY DRAWINGS

FIG. 1 is a schematic diagram of the embodiment 1 according to the eight-way interchange of the invention;

FIG. 2 is a schematic diagram of the embodiment 2 according to the eight-way interchange of the invention.

In the figures: 10, first forked road; 20, second forked road; 30, third forked road; 40, fourth forked road; 50, fifth forked road; 60, sixth forked road; 70, seventh forked road; 80, eighth forked road; 1, first upper accessorial bridge; 2, first lower relief road; 3, first upper downward left-turn relief road; 4, first lower upward left-turn relief road; 5, one-way outward straight lane of the accessorial bridge; 6, one-way inward straight lane of the accessorial bridge; 7, one-way inward straight lane of the forked road; 8, one-way outward straight lane of the relief road; 16, right-turn lane of the first forked road; 27, right-turn lane of the second forked road; 38, right-turn lane of the third forked road; 45, right-turn lane of the fourth forked road; 51, right-turn lane of the fifth forked road; 62, right-turn lane of the sixth forked road; 73, right-turn lane of the seventh forked road; 84, right-turn lane of the eighth forked road; 1001, upper two-way straight lane; 1002, lower two-way straight lane; 1003, second upper accessorial bridge; 1004, second lower relief road; 1005, second upper downward left-turn relief road; 1006, second lower upward left-turn relief road; 1007 upper one-way auxiliary road; 1008, lower one-way auxiliary road; 101, first sign arrow; 102, sign text; 103 second indicating arrow; 104, sign board; 105, support plate; 106, support column; 107, bottom plate; 108, bolt; 109, nut; 110, display screen; 111, through hole; 112, gasket.

### 5. SPECIFIC EMBODIMENT OF THE INVENTION

The technical solutions in the embodiments of the invention are further described clearly and completely with reference to the accompanying drawings in the embodiments of the invention. Obviously, the described embodiments are only part of, but not all, embodiments of the invention.

### EMBODIMENT 1

An eight-way interchange, comprises a first forked road 10, a third forked road 30, a second forked road 20, a fourth forked road 40, a fifth forked road 50, a sixth forked road 60, a seventh forked road 70 and an eighth forked road 80; the first forked road 10, the third forked road 30, the second forked road 20 and the fourth forked road 40 constitute a cross overpass, the first forked road 10 and the third forked road 30 constitute an upper two-way straight lane, the second forked road 20 and the fourth forked road 40 constitute a lower two-way straight lane, the upper two-way straight lane includes two first upper accessorial bridges 1 and two first upper downward left-turn relief roads 3, and the two first upper accessorial bridges 1 are respectively connected to both sides of the upper two-way straight lane; the lower two-way straight lane includes two first lower relief roads 2 and two first lower upward left-turn relief roads 4, the first lower upward left-turn relief roads 4 are respectively connected with the inner sides of the two first lower relief roads 2 and the two first upper accessorial bridges 1, the two first upper downward left-turn relief roads 3 are respectively connected with the two first upper accessorial bridges 1 and the two first lower relief roads 2;

the fifth forked road 50 is connected with the outside of the first lower relief road 2 through the one-way inward straight lane of the forked road 7, and is connected to the outside of the first upper accessorial bridge 1 through the one-way outward straight lane of the accessorial bridge 5; the sixth forked road 60 is connected to the outside of the first upper accessorial bridge 1 through the one-way inward straight lane of the accessorial bridge 6, and is connected to the outside of the first lower relief road 2 through the one-way outward straight lane of the relief road 8; the seventh forked road 70 is connected to the outside of the first lower relief road 2 through the one-way inward straight lane of the forked road 7, and is connected to the outside of the first upper accessorial bridge 1 through the one-way outward straight lane of the accessorial bridge 5; the eighth forked road 80 is connected to the outside of the first upper-floor accessorial bridge 1 through the one-way inward straight lane of the accessorial bridge 6, and is connected to the outside of the first lower relief road 2 through the one-way outward straight lane of the relief road 8;

the first forked road 10 is connected with the outside of the sixth forked road 60 through the right-turn lane of the first forked road 16, the sixth forked road 60 is connected with the outside of the second forked road 20 through the right-turn lane of the sixth forked road 62, the second forked road 20 is connected to the outside of the seventh forked road 70 through the right-turn lane of the second forked road 27, the seventh forked road 70 is connected to the outside of the third forked road 30 through the right-turn lane of the seventh forked road 73, the third forked road 30 is connected to the outside of the eighth forked road 80 through the right-turn lane of the third forked road 38, the eighth forked road 80 is connected to the fourth forked road 40 through the right-turn lane of the eighth forked road 84, the fourth forked road 40 is connected to the outside of the fifth forked road 50 through the right-turn lane of the fourth forked road 45, and the fifth forked road 50 is connected to the first forked road though the right-turn lane of the fifth forked road 51;

the two first upper accessorial bridges 1 are respectively connected to both sides of the upper two-way straight lane, and the two first upper downward left-turn relief roads 3 are respectively connected with the inner sides of the two first upper accessorial bridges 1;

the first forked road 10, the third forked road 30, the second forked road 20, the fourth forked road 40, the fifth forked road 50, the sixth forked road 60, the seventh forked road 70 and the eighth forked road 80 all have a right-turn lane diverging from the left side of the one-way inward straight lane to connect with the adjacent forked road from the outside.

An eight-way interchange, comprises an upper two-way straight lane 1001 and a lower two-way straight lane 1002;

the upper two-way straight lane 1001 includes two second upper accessorial bridges 1003, two second upper downward left-turn relief roads 1005, and two upper one-way auxiliary roads 1007; the two second upper accessorial bridges are respectively connected to the both sides of the upper two-way straight lanes 1001, and the upper one-way auxiliary roads are respectively connected to the second upper accessorial bridges 1003;

the lower two-way straight lane 1002 comprises two second lower relief roads 1004, two second lower upward left-turn relief lanes 1006, and two lower one-way relief roads 1008; the two second lower upward left-turn relief lanes 1006 are respectively connected to the inner side of the two second lower relief roads 1004 and the two second upper accessorial bridges 1003, the lower one-way relief roads 1008 communicates with the second lower relief roads 1004, the two second upper downward left-turn relief roads 1005 are respectively connected to the two second upper accessorial bridges 1003 and the two second lower relief roads 1004.

### EMBODIMENT 2

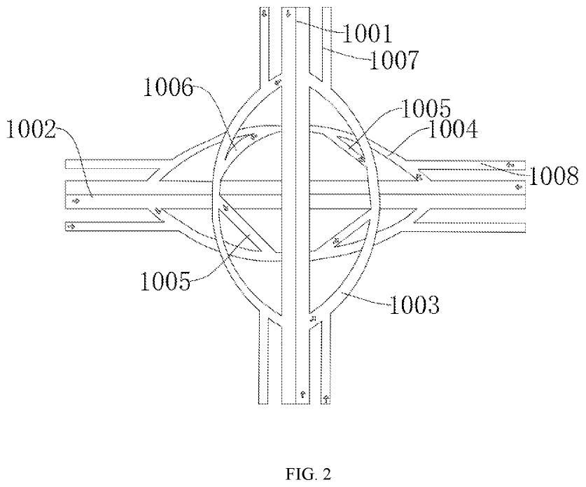

Referring to FIG. 2, an eight-way interchange, comprises an upper two-way straight lane 1001 and a lower two-way straight lane 1002;

the upper two-way straight lane 1001 includes two second upper accessorial bridges 1003, two second upper downward left-turn relief roads 1005, and two upper one-way auxiliary roads 1007; the two second upper accessorial bridges are respectively connected to the both sides of the upper two-way straight lanes 1001, and the upper one-way auxiliary roads are respectively connected to the second upper accessorial bridges 1003;

the lower two-way straight lane 1002 comprises two second lower relief roads 1004, two second lower upward left-turn relief lanes 1006, and two lower one-way relief roads 1008; the two second lower upward left-turn relief lanes 1006 are respectively connected to the inner side of the two second lower relief roads 1004 and the two second upper accessorial bridges 1003, the lower one-way relief roads 1008 communicates with the second lower relief roads 1004, the two second upper downward left-turn relief roads 1005 are respectively connected to the two second upper accessorial bridges 1003 and the two second lower relief roads 1004.

Working Principle:

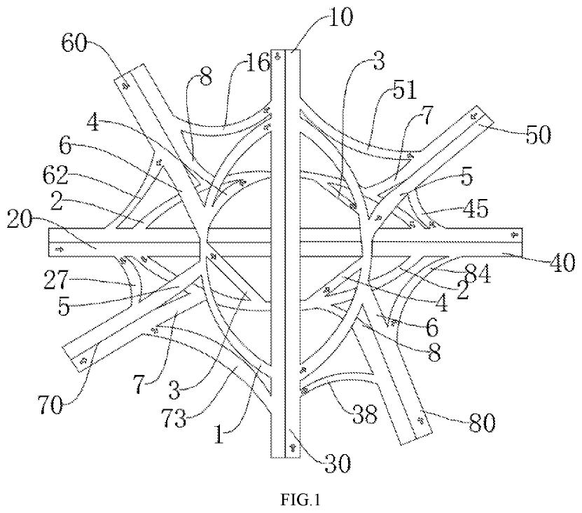

As shown in FIG. 1: The vehicles going straight on the first forked road 10 and the third forked road 30 complete straight driving through the upper straight two-way lane. The vehicles turning left drive into the first upper accessorial bridge 1, then enter the first upper downward left-turn relief roads 3, then go straight along the first lower relief road 2 to complete the left turning. The vehicles turning around drive into the first upper accessorial bridge 1, then enter the first upper downward left-turn relief road 3, then enter the first lower relief road 2, then drive through the first lower upward left-turn relief road 4 and go straight along the first upper accessorial bridge 1 to complete the around turning.

The vehicles going straight on the second forked road 20 and the fourth forked road 40 complete straight driving through the lower straight two-way lane. The vehicles turning left drive into the first lower relief road 2, then enter the first lower upward left-turn relief roads 4, then go straight along the first upper accessorial bridge 1 to complete the left turning. The vehicles turning around drive into the first lower relief road 2, then enter the first lower upward left-turn relief roads 4, then enter the first upper accessorial bridge 1, then drive through the first upper downward left-turn relief road 3 and go straight along the first lower relief road 2 to complete the around turning.

The vehicles on the fifth forked road 50 drive into the first lower relief road 2 through the one-way inward straight lane of the forked road 7, then enter the virtual roundabout through the first lower upward left-turn relief roads 4 to complete turning in any direction; the other vehicles drive into the fifth forked road 50 through the one-way outward straight lane of the accessorial bridge 5. The vehicles on the seventh forked road 70 drive into the first lower relief road 2 through the one-way inward straight lane of the forked road 7, then enter the virtual roundabout through the first lower upward left-turn relief roads 4 to complete turning in any direction; the other vehicles drive into the seventh forked road 70 through the one-way outward straight lane of the accessorial bridge 5.

The vehicles on the sixth forked road 60 drive into the first upper accessorial bridge 1 through the one-way inward straight lane of the accessorial bridge 6, then enter the virtual roundabout through the upper downward left-turn relief road to complete turning in any direction; the other vehicles drive into the sixth forked road 60 through the one-way outward straight lane of the relief road 8. The vehicles on the eighth forked road 80 drive into the first upper accessorial bridge 1 through the one-way inward straight lane of the accessorial bridge 6, then enter the virtual roundabout through the upper downward left-turn relief road to complete turning in any direction; the other vehicles drive into the eighth forked road 80 through the one-way outward straight lane of the relief road 8.

As shown in FIG. 2, the vehicles on the upper bridge complete straight driving along the upper two-way straight lane 1001; the vehicles first drive into the second upper accessorial bridge 1003, drive through the second upper downward left-turn relief road 1005, then go straight along the second lower relief road 1004 to complete the left turning, which only requires a turning of 90 degrees; the vehicles first drive into the second upper accessorial bridge 1003, drive through the second upper downward left-turn relief road 1005, then enter the second lower relief road 1004, go along the second lower upward left-turn relief road 1006 to enter the second upper accessorial bridge 1003, and finally go straight to complete the around turning, which only requires a turning of 180 degrees; the vehicles first drive into the second upper accessorial bridge 1003, drive through the second upper downward left-turn relief road 1005, then enter the second lower relief road 1004, go along the second lower upward left-turn relief road 1006 to enter the second upper accessorial bridge 1003, then go along the second upper downward left-turn relief road 1005 to enter the second lower relief road 1004, and finally go straight to complete the right turning, which requires a turning of 270 degrees; the vehicles on the upper one-way auxiliary road 1007 drive into the second upper accessorial bridge 1003, then enter the virtual roundabout to complete the turning in any direction. The vehicles on the lower bridge complete straight driving along the lower two-way straight lane 1002; first enter the second lower upward left-turn relief road 1006 through the second lower relief road 1004, then go straight along the second upper accessorial bridge 1003 to complete the left turning, which only requires a turning of 90 degrees; the vehicles first drive into the second lower relief road 1004, drive through the second lower upward left-turn relief road 1006, then enter the second upper accessorial bridge 1003, go along the second upper downward left-turn relief road 1005 to enter the second lower relief road 1004, and finally go straight to complete the around turning, which only requires a turning of 180 degrees; the vehicles first enter the second lower upward left-turn relief road 1006 through the second lower relief road 1004, then drive into the second upper accessorial bridge 1003, go along the second upper downward left-turn relief road 1005 to enter the second lower relief road 1004, then go along the second lower upward left-turn relief road 1006 to enter the second upper accessorial bridge 1003, then go straight to complete the right turning, which requires a turning of 270 degrees; the vehicles on the lower one-way auxiliary road 1008 drive straight into the second lower relief road 1004, then enter the virtual roundabout to complete turning in any direction.

Without doubt, as known to those skilled in the art, the working principle and wiring method of the display screen 110 belong to conventional means or common knowledge in the art, and will not be repeated here. Those skilled in the art can make any matching according to their needs or convenience.

The above description is only preferred embodiments of the invention, but the protection scope of the invention is not limited to this. Any equivalent replacements or changes based on the technical solution of the invention and its inventive concept made by any person skilled in the art who is familiar with the technical scope disclosed by the invention should be covered within the protection scope of the invention.

1. An eight-way interchange, comprises a first forked road (10), a third forked road (30), a second forked road (20), a fourth forked road (40), a fifth forked road (50), a sixth forked road (60), a seventh forked road (70) and an eighth forked road (80); the first forked road (10), the third forked road (30), the second forked road (20) and the fourth forked road (40) constitute a cross overpass, the first forked road (10) and the third forked road (30) constitute an upper two-way straight lane, the second forked road (20) and the fourth forked road (40) constitute a lower two-way straight lane, the upper two-way straight lane includes two first upper accessorial bridges (1) and two first upper downward left-turn relief roads (3), and the two first upper accessorial bridges (1) are respectively connected to both sides of the upper two-way straight lane; the lower two-way straight lane includes two first lower relief roads (2) and two first lower upward left-turn relief roads (4), the first lower upward left-turn relief roads (4) are respectively connected with the inner sides of the two first lower relief roads (2) and the two first upper accessorial bridges (1), the two first upper downward left-turn relief roads (3) are respectively connected with the two first upper accessorial bridges (1) and the two first lower relief roads (2);
the fifth forked road (50) is connected with the outside of the first lower relief road (2) through the one-way inward straight lane of the forked road (7), and is connected to the outside of the first upper accessorial bridge (1) through the one-way outward straight lane of the accessorial bridge (5); the sixth forked road (60) is connected to the outside of the first upper accessorial bridge (1) through the one-way inward straight lane of the accessorial bridge (6), and is connected to the outside of the first lower relief road (2) through the one-way outward straight lane of the relief road (8); the seventh forked road (70) is connected to the outside of the first lower relief road (2) through the one-way inward straight lane of the forked road (7), and is connected to the outside of the first upper accessorial bridge (1) through the one-way outward straight lane of the accessorial bridge (5); the eighth forked road (80) is connected to the outside of the first upper-floor accessorial bridge (1) through the one-way inward straight lane of the accessorial bridge (6), and is connected to the outside of the first lower relief road (2) through the one-way outward straight lane of the relief road (8);
the first forked road (10) is connected with the outside of the sixth forked road (60) through the right-turn lane of the first forked road (16), the sixth forked road (60) is connected with the outside of the second forked road (20) through the right-turn lane of the sixth forked road (62), the second forked road (20) is connected to the outside of the seventh forked road (70) through the right-turn lane of the second forked road (27), the seventh forked road (70) is connected to the outside of the third forked road (30) through the right-turn lane of the seventh forked road (73), the third forked road (30) is connected to the outside of the eighth forked road (80) through the right-turn lane of the third forked road (38), the eighth forked road (80) is connected to the fourth forked road (40) through the right-turn lane of the eighth forked road (84), the fourth forked road (40) is connected to the outside of the fifth forked road (50) through the right-turn lane of the fourth forked road (45), and the fifth forked road (50) is connected to the first forked road though the right-turn lane of the fifth forked road (51);
the two first upper accessorial bridges (1) are respectively connected to both sides of the upper two-way straight lane, and the two first upper downward left-turn relief roads (3) are respectively connected with the inner sides of the two first upper accessorial bridges (1);
the first forked road (10), the third forked road (30), the second forked road (20), the fourth forked road (40), the fifth forked road (50), the sixth forked road (60), the seventh forked road (70) and the eighth forked road (80) all have a right-turn lane diverging from the left side of the one-way inward straight lane to connect with the adjacent forked road from the outside.

2. The eight-way interchange according to claim 1, wherein the number of lanes of the upper two-way straight lane and the lower two-way straight lane is six, the lane number of the first forked road (10), the third forked road (30), the second forked road (20), the fourth forked road (40), the fifth forked road (50), the sixth forked road (60), the seventh forked road (70) and the eighth forked road (80) is two-way 6-lane, and the number of the right-turn lanes that diverge from the one-way inward straight lane of eight forked roads is respectively two.

3. The eight-way interchange according to claim 1, wherein the number of lanes on the first lower relief road (2) and the two first lower upward left-turn relief roads (4) is four, and the virtual roundabouts formed have corresponding traffic signs.

4. The eight-way interchange according to claim 1, wherein the first forked road (10), the third forked road (30), the second forked road (20), the fourth forked road (40), the fifth forked road (50), the sixth forked road (60), the seventh forked road (70) and the eighth forked road (80) are all provided with corresponding traffic signs of crossing prohibition and isolation belts.

5. The eight-way interchange according to claim 1, comprises an upper two-way straight lane (1001) and a lower two-way straight lane (1002),
wherein the upper two-way straight lane (1001) includes two second upper accessorial bridges (1003), two second upper downward left-turn relief roads (1005), and two upper one-way auxiliary roads (1007); the two second upper accessorial bridges are respectively connected to the both sides of the upper two-way straight lanes (1001), and the upper one-way auxiliary roads are respectively connected to the second upper accessorial bridges (1003);
the lower two-way straight lane (1002) comprises two second lower relief roads (1004), two second lower upward left-turn relief lanes (1006), and two lower one-way relief roads (1008);
the two second lower upward left-turn relief lanes (1006) are respectively connected to the inner side of the two second lower relief roads (1004) and the two second upper accessorial bridges (1003), the lower one-way relief roads (1008) communicates with the second lower relief roads (1004), the two second upper downward left-turn relief roads (1005) are respectively connected to the two second upper accessorial bridges (1003) and the two second lower relief roads (1004).
